(19) United States
(12) Patent Application Publication
(10) Pub. No.: US 2004/0116637 A1
(43) Pub. Date: Jun. 17, 2004

(54) Method for producing a polymeric conversion product

(76) Inventors: Roman Benedikt Raether, Limburgerhof (DE); Wolfgang Bremser, Muenster (DE); Yvonne Heischkel, Mannheim (DE)

Correspondence Address: KEIL & WEINKAUF, 1350 CONNECTICUT AVENUE, N.W., WASHINGTON, DC, 20036, US

(21) Appl. No.: 10/473,745

(22) PCT Filed: Apr. 5, 2002
(86) PCT No.: PCT/EP02/03820

(30) Foreign Application Priority Data
Apr. 6, 2001 (DE) 101 17 276.1

(51) Int. Cl. C08F 20/44

(52) U.S. Cl. 526/317.1; 526/319; 526/346; 526/335; 526/341

(57) ABSTRACT

A polymeric reaction product is prepared by a process comprising a reaction, under free radical conditions, of a reaction mixture containing at least one monomer (a) capable of undergoing free radical reactions, in the presence of a compound (I) of the formula:

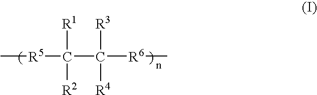

and said reaction product is used for the production of moldings, films, fibers and foams.

The present invention relates to a process for the preparation of a polymeric reaction product, and polymeric reaction products which can be prepared by a novel process and their use according to the invention.

The novel process is particularly suitable for the preparation of copolymers, for example having block structures. The literature discloses various processes for the preparation of such polymers.

Free radical polymerization processes for the preparation of homo- and copolymers are described in U.S. Pat. No. 4,581,429 or EP-A 0 135 280, for example. Although the nitroxyl containing initiators used there make it possible to control the synthesized polymer structures, the synthesis is complicated since the individual monomers have to be added in succession for the preparation of copolymers having block structures.

WO 00/37507 describes a process for the preparation of a reaction product (A) by reaction under free radical conditions, the reaction having features which are typical of the living polymerization system. The reaction of a monomer capable of undergoing free radical reactions takes place in the presence of at least one free radical initiator and of a compound (I) in the aqueous phase. The present invention also relates to the reaction product per se, a process for the preparation of a polymer using this reaction product, and its use in polymer dispersions.

DE 10029695.5 and PCT/EP 00/12848 each relate to a process for the preparation of a polymeric reaction product (A) by a reaction under free radical conditions and the corresponding reaction products and their use. In DE 10029694.7, the use of such polymeric reaction products for various purposes is described in more detail.

DE 10029695.5 describes a process for the preparation of a reaction product (A), comprising a reaction, under free radical conditions, of a reaction mixture comprising at least one monomer (a) capable of undergoing free radical reactions, in the presence of at least one compound of the formula (I)

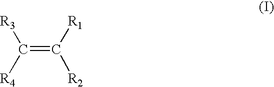

and a process for the preparation of a reaction product (A′), comprising a reaction, under free radical conditions, of a reaction mixture comprising at least one monomer (a) capable of undergoing free radical reactions, in the presence of at least one compound of the formula (II)

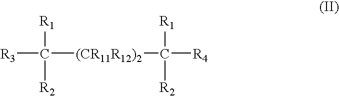

PCT/EP 00/12848 describes processes for the preparation of a reaction product (A), comprising a reaction, under free radical conditions, of a reaction mixture comprising at least one monomer (a) capable of undergoing free radical reactions, in the presence of at least one free radical initiator and a compound (I) of the formula

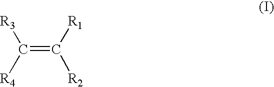

10% by weight or less of water being present in the reaction mixture.

DE 10029697.1 relates to solids-containing binder compositions at least containing block copolymers prepared by free radical polymerization and at least 2% by weight of at least one nonmagnetic and nonmagnetizable inorganic or organic solid, a process for the preparation of such binder compositions and their use. The block copolymers have at least two blocks of different monomer compositions.

DE 10029699.8 describes magnetic and magnetizable binder compositions, processes for their preparation and their use. The novel binder compositions contain at least one block copolymer preparable by free radical polymerization and having at least two blocks of different monomer compositions and at least one magnetic or magnetizable pigment.

The product formed in the preparation of copolymers by free radical polymerization are frequently difficult to control in their physical or chemical properties.

Greater control is permitted, for example, by anionic processes. WO 95/34586 describes a process for the preparation of styrene copolymers which is initiated by means of organometallic compounds. DE-A 199 10 339 describes the use of such polymers in thermoplastic molding materials. The use for the preparation of glass fiber-reinforced thermoplastic molding materials is described in DE-A 198 05 586.

Ionic processes, in particular the anionic processes described above, must be carried out with strict exclusion of oxygen and water, which leads to high costs of the starting materials. Moreover, the initiators used are generally toxic.

It is a primary object of the present invention to provide a process for the preparation of a polymeric reaction product, in which economical raw materials can be used and which is industrially applicable. It is a further object of the present invention to permit control of properties of polymers and hence a wide range of potential uses of those polymers which are obtainable by simple free radical polymerization.

We have found that this object is achieved, according to the invention, by a process for the preparation of a polymeric reaction product, comprising a reaction, under free radical conditions, of reaction mixtures containing at least one monomer (a) capable of undergoing free radical reactions, in the presence of a compound (I) of the formula:

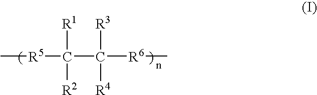

where

R¹ to R⁴, in each case independently of one another, are hydrogen, straight-chain or branched substituted or unsubstituted alkyl or cycloalkyl groups or substituted or unsubstituted aralkyl, alkylaryl or aryl groups, with the proviso that at least two of the radicals R¹ to R⁴ is a substituted or unsubstituted aromatic hydrocarbon of 6 to 18 carbon atoms or a functional group which has, conjugated with the C-C bond in the formula I, a multiple bond between a carbon atom and a heteroatom,

R⁵ and R⁶, in each case independently of one another, are a substituted or unsubstituted straight-chain or branched alkyl group or a substituted or unsubstituted aralkyl, alkylaryl or aryl group, it also being possible for R⁵ and R⁶ to have a polymeric character, and

n is from 1 to 100, the compound (I) not being prepared by controled free radical polymerization.

In the context of the present invention, controled free radical polymerization is understood as meaning a free radical polymerization which takes place in the presence of a compound which forms a stable free radical and is characterized by successive controled monomer incorporation.

The advantage of the novel process starting from compound (I) lies in the reaction procedure under free radical conditions. In this reaction procedure, no strict exclusion of moisture or the use of highly pure starting materials is required, in contrast to the processes used to date under anionic or cationic reaction conditions for the preparation of copolymers.

In the novel process, the growing polymer radical is not terminated by combination or disproportionation as in the case of other reactions under free radical conditions but reacts with the compound (I), it being possible for one of the radicals R⁵ or R⁶ to be transferred. If R⁵ and R⁶ have a polymeric character, copolymers which contain blocks of the monomer (a) and the radicals R⁵ or R⁶ are obtained.

The compound (I) can be prepared in principle by all known methods of organic chemistry, except for controled free radical polymerization. For example, free radical methods as described in Bulletin Chem. Soc. Jap. 40 (1967), 2569 and in J. Polymer Sci., Part B, 8 (1970), 499 are suitable. Particularly suitable, however, are also ionic polymerization methods, in particular anionic processes, as described in WO 95/34586 in which a polymerization is initiated by means of organometallic compounds. Cationic polymerization methods, as described, for example, by Feldhusen et al., Macromolecules 31 (1997), 578 are also suitable.

R¹ and R² or R³ and R⁴ are in particular a substituted or unsubstituted aromatic hydrocarbon of 6 to 18 carbon atoms.

In a particularly preferred embodiment of the present invention, R¹ and R² or R³ and R⁴ are phenyl derivatives. It is particularly preferable if R¹ and R² or R³ and R⁴ are a phenyl radical and the respective other radicals R¹ and R² or R³ and R⁴ are hydrogen.

In the present invention, a polymeric character is understood as meaning that a radical consists of at least two repeating units, Preferably, a radical having a polymeric character consists of at least ten repeating units.

Accordingly, the present invention relates in particular to a process for the preparation of a polymeric reaction product, where R⁵ or R⁶ or both is or are composed of at least two repeating units.

R⁵ and R⁶ may be composed of, for example, from 1 to 100 000, in particular from 1 to 10 000, repeating units.

Particularly preferred repeating units are those which are derived from a monomer (a) capable of undergoing free radical reactions.

The reaction under free radical conditions is carried out in principle under the conventional conditions for a free radical polymerization, it being possible for suitable solvents to be present.

If the reaction described is carried out in the aqueous phase, the term aqueous phase in the context of the present text is understood as meaning a phase which contains from 10 to 100% by weight of water. If the water content of the aqueous phase is less than 10%, it is preferable in the present invention if the aqueous phase contains a mixture of water and one or more water-miscible solvents, such as tetrahydrofuran, methanol, ethanol, propanol, butanol, acetone, methyl ethyl ketone or the like. However, it is also possible to carry out the reaction in the presence of a mixture of water and a water-immiscible solvent, such as an aromatic solvent, for example toluene.

It is however also possible to carry out the reaction in an organic solvent or in the absence of a solvent, for example in the melt, When the expression a reaction procedure in an organic solvent or in the absence of a solvent is used in the context of the present invention, it is understood as meaning a reaction procedure which takes place in the presence of less than 10, preferably less than 5 or less than 1% by weight of water. In a further embodiment of the present invention, the reaction is carried out in the absence of water, i.e. with a water content of less than 0.001% by weight. Such water contents can be achieved, for example, by the use of commercially available solvents, as are usually used as organic solvents in free radical polymerizations.

Suitable solvents in the context of the present invention are in principle all polar and nonpolar organic solvents in which the corresponding monomers and also the resulting polymers are soluble, if necessary at elevated temperatures. Suitable solvents are, for example, C3 to C10 alkanes, cyclohexane, decalin, acetone, methyl ethyl ketone, diisobutyl ketone, tetrahydrofuran, dioxane, benzene, toluene, dimethylformamide, dimethylacetamide, N-methylpyrrolidone, glycols, such as ethylene glycol and triethylene glycol, partly or completely end-capped glycol ethers, such as ethylene glycol monomethyl ether, ethyl acetate, methanol and ethanol and the higher homologs of the alkanols of up to 18 carbon atoms (if necessary as cosolvents) and mixtures of two or more thereof. Methyl ethyl ketone and toluene are particularly preferred as solvents.

The reaction under free radical conditions is generally carried out at above room temperature and below the decomposition temperature of the monomers, preferably a temperature range of from 50 to 150° C., more preferably from 60 to 120° C., in particular from 75 to 95° C., being chosen.

The reaction can be carried out at presssures of from 1 to 300, for example from about 1 to about 20 bar. The reaction is preferably carried out at atmospheric pressure.

The reaction can also be carried out in the presence of a surfactant.

According to the invention, the free radical formation can be carried out by different methods. Thus, thermal, photochemical, electrochemical or electron transfer-induced production is just as possible as the use of oxidizing agents or reducing agents for free radical production. In addition, the free radical production can also be effected mechanically, for example by shear degradation or ultrasonics.

In a further embodiment, the present invention accordingly relates to a process for the preparation of a polymeric reaction product, the reaction mixture additionally containing an initiator.

In addition to carrying out the reaction in the presence of at least one free radical initiator, thermally, electrochemically or photochemically initiating monomers may also be used as initiators. Preferably, all azo and/or peroxo compounds and/or compounds having homolytically cleavable C-C bonds which are conventionally used in free radical chain polymerization may be employed. Suitable initiators are described in WO 98/01478, page 10, line 17 to page 11, line 15 which is hereby fully incorporated in the context of the present application; 3,4-dimethyl-3,4-diphenylhexane and 2,3-dimethyl-2,3-diphenylbutane may also be used. Preferably used initiators are those which are soluble in the reaction system used in each case. In the case of a reaction in the aqueous phase, an oxidizing free radical initiator, e.g. potassium, sodium or ammonium peroxodisulfate, or a combination of a conventional, i.e. of a nonoxidizing, initiator with H₂O₂, is preferably used. Dicumyl peroxide, dibenzoyl peroxide, dilauryl peroxide and AIBN may also be used.

In a preferred embodiment of the novel process, a comparatively large amount of free radical initiator is added, the amount of free radical initiator in the reaction mixture being preferably from 0.1 to 50, more preferably from 0.5 to 20% by weight, based in each case on the total amount of the monomer (a) and of the initiator. Preferably, the molar ratio of initiator to the repeating unit R⁵C(R¹R²)C(R³R⁴)R⁶ of the compound (I) is from 5:1 to 1:5, for example from 3:1 to 1:3, more preferably from 2:1 to 1:2, in particular from 1.5;1 bis 1:1.5.

Depending on the reaction procedure, it is possible in the novel process to prepare polymers functionalized at the terminal groups, block or multiblock and gradient (co)polymers, star polymers, graft copolymers and branched (co)polymers.

In a preferred embodiment, the present invention relates to a process for the preparation of a polymeric reaction product, said reaction product being a block copolymer.

In the context of the present invention, a block copolymer is understood as meaning a polymer which has at least two polymer blocks characterized by different monomer compositions. In the context of the present invention, polymer blocks characterized by different monomer compositions is understood as meaning the finding that at least two regions of the block copolymer have at least two blocks having different monomer compositions. In the present invention, it is possible for the transition between two blocks to be continuous, i.e. for there to exist between two blocks a zone which has a random or regular sequence of the monomers constituting the blocks. In the context of the present invention, however, it is envisaged that the transition between two blocks is substantially discontinuous. A substantially discontinuous transition is understood as meaning a transition zone which has a substantially smaller length than at least one of the blocks separated by the transition zone. In a preferred embodiment of the present invention, the chain length of such a transition zone is less than 1/10, preferably less than 1/20, of the block length of at least one of the blocks separated by the transition zone.

In the context of the present invention, different monomer compositions is understood as meaning the finding that the monomers constituting the respective block differ in at least one feature, for example in their linkage to one another, in their conformation or in their constitution. In the present invention, block copolymers which have at least two blocks whose monomer compositions differ at least through the constitution of the monomers are preferably used.

In a preferred embodiment, the block copolymers which can be prepared in the present invention have a polydispersity of less than about 5, for example less than about 4 or less than about 3.

The block copolymers which can be prepared according to the invention have, for example, a molecular weight (Mₙ) of from 500 to 1 000 000, in particular from 5 000 to 500 000 g/mol. The molecular weights are determined by GPC in tetrahydrofuran, based on a polystyrene standard.

Particularly suitable monomers (a) capable of undergoing free radical reactions are ethylenically unsaturated monomers.

Examples of suitable monomers having at least one ethylenically unsaturated group are olefins, such as ethylene or propylene, vinylaromatic monomers, such as styrene, divinylbenzene, 2-vinylnaphthalene and 9-vinylanthracene, substituted vinylaromatic monomers, such as p-methylstyrene, α-methylstyrene, o-chlorostyrene, p-chlorostyrene, 2,4-dimethylstyrene, 4-vinylbiphenyl and vinyltoluene, esters of vinylalcohol and monocarboxylic acids of 1 to 18 carbon atoms, such as vinyl acetate, vinyl propionate, vinyl n-butyrate, vinyl laurate and vinyl stearate, anhydrides or esters of α,β-monoethylenically unsaturated mono-and dicarboxylic acids of 3 to 6 carbon atoms, in particular acrylic acid, methacrylic acid, maleic acid, fumaric acid and itaconic acid, with alkanols of in general from 1 to 20, preferably 1 to 12, particularly preferably 1 to 8, very particularly preferably 1 to 4, carbon atoms, in particular methyl, ethyl, n-butyl, isobutyl, tert-butyl and 2-ethylhexyl acrylate and methacrylate, dimethyl maleate or n-butyl maleate, or the esters of said carboxylic acids with alkoxy compounds, for example ethylene oxide or polyethylene oxide, such as ethylene oxide acrylate or methacrylate, the nitriles of the abovementioned α,β-monoethylenically unsaturated carboxylic acids, such as acrylonitrile and methacrylonitrile, and conjugated C₄₋₈ dienes, such as 1,3-butadiene and isoprene, and N-vinyl compounds, for example N-vinylpyrrolidone and N-vinylformamide.

Suitable styrene compounds are those of the formula II:

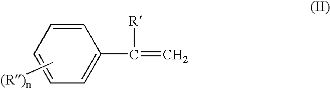

where R′ and R″, independently of one another, are H or C₁-to C₈-alkyl and n is 0, 1, 2 or 3.

The monomers styrene, α-methylstyrene, divinylbenzene, vinyltoluene, N-vinylpyrrolidone and N-vinylformamide, C₁- to C₂₀-alkyl acrylates and C₁- to C₂₀-alkyl methacrylates, in particular n-butyl acrylate, 2-ethylhexyl acrylate or methyl methacrylate, and butadiene, as well as maleic acid and maleic anhydride, acrylonitrile, glycidyl esters and (poly)alkoxylates of acrylic and methacrylic acid, and monomer mixtures which are composed of at least 85% by weight of the abovementioned monomers or mixtures of the abovementioned monomers, very particularly preferably styrene and methyl methacrylate, are particularly preferably used in the novel process.

In a preferred embodiment, the present invention accordingly relates to a process for the preparation of a polymeric reaction product, wherein the monomer (a) capable of undergoing free radical reactions is selected from the group consisting of:

styrene compounds of the formula (II)

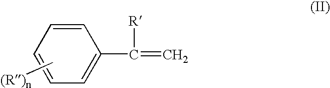

where R′ and R″, independently of one another, are H or C₁-C₈-alkyl and n is 0, 1, 2 or 3;

acrylic acid or methacrylic acid or their C₁-C₂₀-alkyl esters or their C₁-C₁₀₀-alkoxy esters;

dienes having conjugated double bonds;

ethylenically unsaturated dicarboxylic acids and their derivatives;

N-vinyl compounds

and ethylenically unsaturated nitrile compounds.

The present invention also relates to a polymeric reaction product A which can be prepared by means of a process according to the invention.

According to the invention, the polymeric reaction product A may be, for example, a copolymer having blocks consisting of polystyrene, methyl methacrylate, methacrylate, N-vinylpyrrolidone or poly(styrene-co-maleic anhydride) or olefins.

The present invention furthermore relates to the use of a polymeric reaction product which can be prepared by a novel process or of a novel polymeric reaction product for the production of moldings, films, fibers and foams.

The examples which follow illustrate the invention.

### EXAMPLES

Poly(styrene-co-1,1-diphenylethene) was prepared according to WO 95/34586 via the anionic copolymerization of styrene and diphenylethene (DPE).

### Example 1

7.5 g of poly(styrene-co-1,1-diphenylethene) (Mₙ=92 000 g/mol, PD=1.81) and 0.03 g of 2,2′-azobis(2-isobutyronitrile) were dissolved in 30 g of methyl methacrylate and 3 g of toluene and then kept at 95° C. for 2 hours. The polymer formed was dissolved in tetrahydrofuran and precipitated in diethyl ether. The polymer obtained had a molecular weight Mₙ of 74 000 g/mol and a dispersity PD of 1.88.

### Example 2

2.5 of poly(styrene-co-1,1-diphenylethene) (Mₙ=92 000 g/mol, PD=1.81) were dissolved in 10 g of methyl methacrylate and then kept at 105° C. for 4 hours. The polymer formed was dissolved in tetrahydrofuran and precipitated in diethyl ether. The polymer obtained had a molecular weight Mₙ of 63 000 g/mol and a dispersity PD of 2.10.

### Example 3

In a high-pressure reactor, first ethene was polymerized at 1 300 bar and 260° C. After a stable ethene polymerization had been established, poly(styrene-co-1,1-diphenylethene) (Mₙ=92 000 g/mol, PD=1.81) dissolved in toluene was pumped in. The temperature in the reactor increased to 295° C. The ethene/styrene block copolymer formed exhibited the band characteristic of phenyl groups at 1 610 cm₋₁ in the infrared spectrum, even after extraction with cyclohexane.

We claim:

1. A process for the preparation of a polymeric reaction product, comprising a reaction, under free radical conditions, of a reaction mixture containing at least one monomer (a) capable of undergoing free radical reactions, in the presence of a compound (I) of the formula: 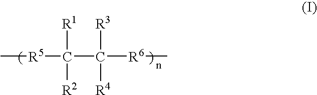
where
R¹ to R⁴, in each case independently of one another, are hydrogen, straight-chain or branched substituted or unsubstituted alkyl or cycloalkyl groups or substituted or unsubstituted aralkyl, alkylaryl or aryl groups, with the proviso that at least two of the radicals R¹ to R⁴, are a substituted or unsubstituted aromatic hydrocarbon of 6 to 18 carbon atoms or a functional group which has, conjugated with the C-C bond in the formula I, a multiple bond between a carbon atom and a heteroatom,
R⁵ and R⁶, in each case independently of one another, are a substituted or unsubstituted straight-chain or branched alkyl group or a substituted or unsubstituted aralkyl, alkylaryl or aryl group, it also being possible for R⁵ and R⁶ to have a polymeric character, and
n is from 1 to 100, the compound (I) not being prepared by controled free radical polymerization.

2. A process for the preparation of a polymeric reaction product as claimed in claim 1, wherein the reaction mixture contains an initiator.

3. A process for the preparation of a polymeric reaction product as claimed in either of claims 1 and 2, wherein the polymeric reaction product is a block copolymer.

4. A process for the preparation of a polymeric reaction product as claimed in any of claims 1 to 3, wherein R¹ and R² or R³ and R⁴ are a substituted or unsubstituted aromatic hydrocarbon of 6 to 18 carbon atoms.

5. A process for the preparation of a polymeric reaction product as claimed in any of claims 1 to 4, wherein R¹ and R² or R³ and R⁴ are phenyl derivatives.

6. A process for the preparation of a polymeric reaction product as claimed in any of claims 1 to 5, wherein R¹ and R² or R³ and R⁴ are a phenyl radical and the respective other radicals R¹ and R² or R³ and R⁴ are hydrogen.

7. A process for the preparation of a polymeric reaction product as claimed in any of claims 1 to 6, wherein R⁵ or R⁶ or both is or are composed of at least two repeating units.

8. A process for the preparation of a polymeric reaction product as claimed in any of claims 1 to 7, wherein the monomer (a) capable of undergoing free radical reaction is selected from the group consisting of;
styrene compounds of the formula (II) 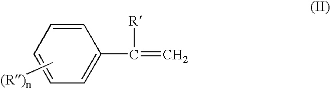
where R′ and R″, independently of one another, are H or C₁-C₈-alkyl and n is 0, 1, 2 or 3;
acrylic acid or methacrylic acid or their C₁-C₂₀-alkyl esters or their C₁-C₁₀₀-alkoxy esters;
dienes having conjugated double bonds;
ethylenically unsaturated dicarboxylic acids and their derivatives;
N-vinyl compounds
and ethylenically unsaturated nitrile compounds.

9. A polymeric reaction product A which can be prepared by means of a process as claimed in any of claims 1 to 8.

10. The use of a polymeric reaction product which can be prepared by a process as claimed in any of claims 1 to 8 or of a polymeric reaction product as claimed in claim 9 for the production of moldings, films, fibers and foams.
